(19) United States
(12) Patent Application Publication
(10) Pub. No.: US 2005/0112043 A1
(43) Pub. Date: May 26, 2005

(54) Apparatus for improving air quality

(76) Inventors: Ralph C. Sparling, Cloudcroft, NM (US); Lance C. Grace, Alamogordo, NM (US); Lincoln D. Busselle, Albuquerque, NM (US)

Correspondence Address: PAUL, HASTINGS, JANOFSKY & WALKER LLP, P.O. BOX 919092, SAN DIEGO, CA, 92191-9092, US

(21) Appl. No.: 10/912,782

(22) Filed: Aug. 5, 2004

Related U.S. Application Data
(63) Continuation of application No. 09/824,115, filed on Apr. 2, 2001, now abandoned.
Application No. 09/824,115 is a continuation-in-part of application No. 09/368,837, filed on Aug. 5, 1999, now Pat. No. 6,237,587.

(51) Int. Cl. C01B 3/00; B01J 8/00; B01D 47/00; F01N 3/00; B01J 8/02; C01B 21/00; C01B 23/00; C01B 25/00; C01G 28/00; C01G 30/00; C01B 31/00; C01B 33/00; C01B 35/00

(52) U.S. Cl. 423/210; 423/213.5; 422/177; 422/174

(57) ABSTRACT

Pollutants in air or other fluids are converted to harmless compounds by positioning a catalyst coated reticulated foam in the path of the fluid flow. The reticulated foam is a three dimensional latticework of interconnected ligaments forming a porous, open-celled structure with a large internal surface area. Internal surfaces of the reticulated foam are coated with the catalyst. Catalytic conversion efficiency is maintained by fluid heat, an internal heating source, or external sources, such as combustion processes and radiation illumination.

This application is a continuation-in-part of Ser. No. 09/368,837 filed Aug. 6, 1999 entitled WOODBURNING FIREPLACE EXHAUST CATALYTIC CLEANER.

### BACKGROUND OF THE INVENTION

1. Field of the Invention

The invention pertains to the maintenance of air quality, and more particularly to the reduction of air pollutants contained in air, both indoor and outdoor.

2. Description of the Prior Art

In recent years the quality of the air has received major consideration. Clean air has become more than a phrase. Significant efforts have been expended to minimize pollutants in the air we breathe. Some examples of these efforts are: emission standards have been imposed on automobile exhausts, incinerators in apartment houses have been shut down, and large garbage burning incinerators must meet established standards or be shut down.

Though air pollution has traditionally been viewed as an outdoor problem, it has recently been shown that indoor pollution may be more of a health hazzard than outdoor pollution, caused mainly by the combustion of fossilized fuels to produce electrical and mechanical energy. Of major concern are pollutants such as particulate organic carbon monoxide (CO), a wide variety of organic material, and nitrogen oxides (NOx). Many of these compounds are created as the waste products of natural or man-made combustion processes while others occur strictly naturally such as airborne bacteria, viruses, and pollen.

In the prior art catalytic converters and foam material have been utilized as filters to reduce pollutants in fluid streams and the air we breathe. Since polymer reticulated foams cannot tolerate elevated temperatures, catalytic devices, such as catalytic converters, utilize metallic structures or ceramic honeycombs as substrate materials for catalytic devices that must operate in a high temperature environment.

One catalytic system of the prior art for indoor air quality (IAQ) improvement passes the air from which pollutants are to be removed over a semiconductor catalyst which reacts to ultraviolet radiation. As photons of ultraviolet light are absorbed by the semiconductor, hydroxyl radicals are created that cause the destruction of chemical and microbiological contaminants in the passing air.

### SUMMARY OF THE INVENTION

In accordance with the principles of the present invention an air quality improvement apparatus includes a reticulated foam having a ceramic substrate coated with catalytic material placed in the path of the air to be cleansed. Reticulated foam is a three-dimensional latticework of interconnected ligaments forming a porous, open-celled structure. Matter forming the structure covers only 5 to 10 percent of the overall volume. Thus, reticulated foam has an extremely large surface area per volume. Coating the surface area with catalytic material causes air or other fluids flowing therethrough to be exposed to large surface areas of pollutant conversion material. Efficient conversion temperature is maintained by thermostatically controlled heating elements embedded in the reticulated foam, coupling a thermostatically controlled electrical source directly to the substrate, by radiated energy from an external source, or by a combustion source from which pollutants are to be reduced.

### BRIEF DESCRIPTION OF THE DRAWINGS

FIG. 1 is a schematic diagram of an apparatus for reducing pollutants from air or other fluids flowing therethrough.

FIG. 2 is a schematic diagram of a catalytic converter which may be utilized in the apparatus of FIG. 1.

FIG. 3 is a schematic diagram of a catalytic converter within the flame of a combustion source.

FIG. 4 is a representation of a catalytic converter comprising one or more sheets of reticulated foam.

FIG. 5 is a magnified representation of a group of cells in the reticulated foam of FIG. 4.

FIG. 6 is a graph showing the number of cells per linear inch in a reticulated foam as a function of the reticulated foam volume.

FIG. 7 is a graph showing the pressure drop across a reticulated foam as a function of the number of cells per inch and the velocity of air flowing through the reticulated foam.

FIG. 8 is a diagram of an exhaust catalytic cleaner comprising a heater element sandwiched between two sections of reticulated foam, each coated with catalytic material.

FIG. 9 is a diagram of a spiral electrical heater coil suitable for use as the heater element in FIG. 8.

FIG. 10 is a diagram of an exhaust catalytic cleaner comprising two sections of reticulated foam, coated with catalytic material, having provision for inserting a heating element between the two sections.

FIG. 10A is a diagram of a circular helical coil which may be employed as the heating element in the exhaust catalytic cleaner diagramed in FIG. 10.

FIG. 11 is a diagram of a high resistance electrical conducting material, constructed in a manner to allow fluid to flow therethrough, coated with a catalyst and embodied in a reticulated foam comprising a ceramic material coated with a catalyst.

FIG. 12 is a diagram of a block of reticulated foam, coated with catalytic material, through which a heating element is woven.

FIG. 13 is a diagram of a reticulated foam coated with a catalytic material through which electrical current may flow for heating the unit.

FIG. 14 is a diagram of a reticulated foam coated with a low temperature, nonionizing, radiation activated catalyst illuminated by a radiation source.I

### DESCRIPTION OF THE PREFERRED EMBODIMENTS

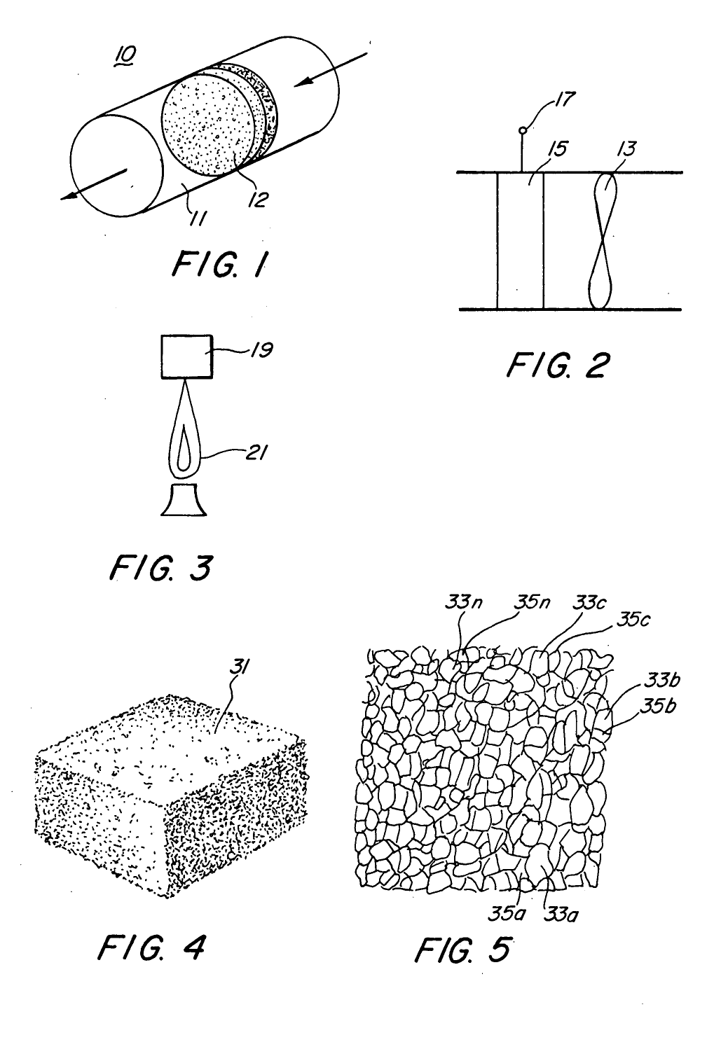

Refer-now to FIG. 1, wherein a schematic diagram of an apparatus 10 for reducing pollutants in air or other fluids is shown. Fluids from which pollutants are to be removed are lead to a guide 11 and directed through a catalytic converter 12, which converts pollutants in the fluid to harmless compounds, to emerge from the guide with pollutants in the fluid significantly reduced. A converter that may be employed in the guide is shown schematically in FIG. 2. A fan 13, for maintaining fluid flow, is positioned in the guide prior to a catalytic foam structure 15, which accomplishes pollutant reduction in the fluid. An energy source, not shown, may be coupled to the catalytic foam structure via a coupler 17 to maintain the catalytic foam structure at an efficient operating temperature.

Pollutants emitted from combustion processes may be reduced by positioning a catalytic converter 19 near the combustion source in the path of emissions or at the combustion source, as shown in FIG. 3. When positioned in this manner, the catalytic converter 19 may be maintained at an efficient operating temperature by the temperature of the emissions or the temperature of the combustion source. In addition to reducing pollutants due to the combustion process, positioning a catalytic foam structure at the combustion source provides improved combustion efficiency, that is a higher converted thermal efficiency, and more uniform heating.

Reticulated foam is a porous, three dimensional lattice structure of interconnected ligaments arranged to form an open-celled structure which has a very high internal surface area per foam volume. Reticulated foam, a block of which is shown in FIG. 4, appears somewhat like a sponge. Since the majority of the block comprises space between interconnected ligaments, reticulated foam has a very low material density. This low material density is illustrated in FIG. 5, which is a blown up slice of the block shown in FIG. 4. As shown in FIG. 5, the foam includes a series of interconnected cells (pores) 33a through 33n formed by ligaments 35a through 35n surrounding the cells. As may be inferred from FIG. 5, each pore is connected to a large number of adjacent pores, normally 12 or more.

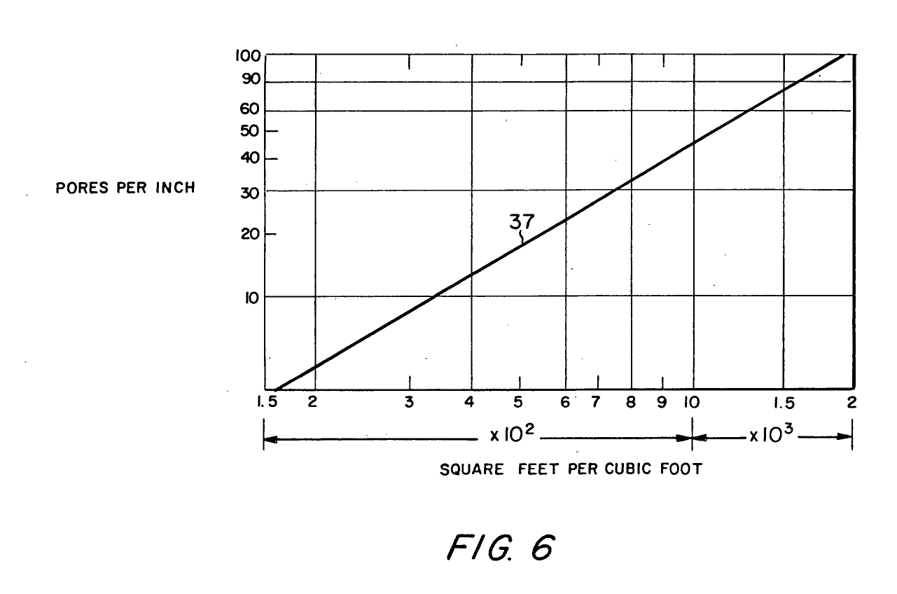

Pore dimensions are kept relatively constant throughout a block of reticulated foam. Thus the internal surface area per volume of a block of reticulated foam is determined by the number of cells per linear inch within the block. FIG. 6 is a graph relating the number of pores per linear inch to the internal surface area per cubic foot of a typical reticulated foam. The relationship is logarithmic, thus, when plotted on a log-log grid the relationship is shown as a straight line 37. As an example of the use of the graph, if one desires a foam having 320 square feet of internal surface area per cubic foot, one should provide 10 pores per linear inch of foam.

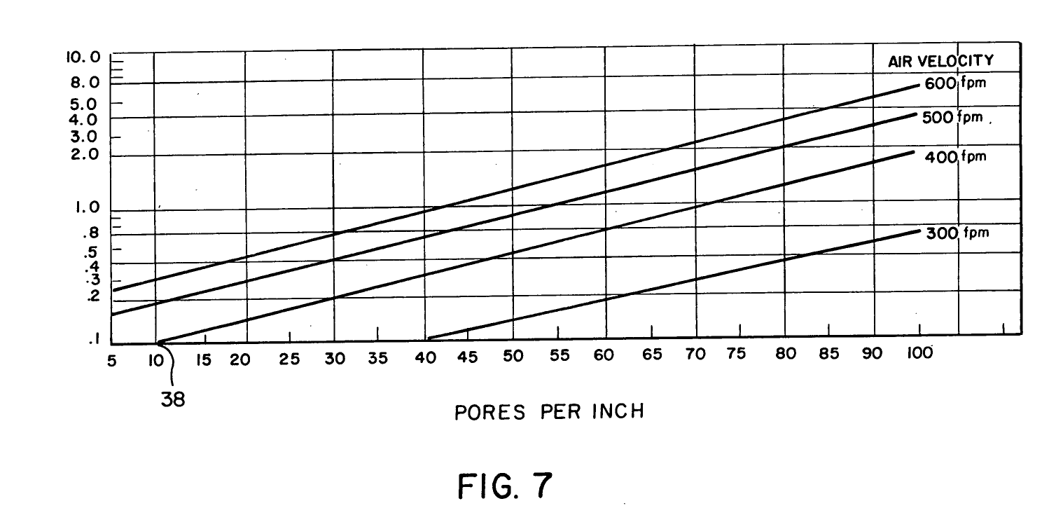

When designing a reticulated foam catalytic converter for a particular application care must be taken to provide an appropriate pressure drop across the converter. For example, a fireplace is an open device. Consequently, there exists a relatively low differential draft pressure between the front of the fireplace and the flue. Any catalytic cleaner, therefore, for use between the smoke chamber and the flue must not have a back pressure that drops the differential draft pressure below that which directs the smoke to the flue. Though increasing the number of pores per linear inch increases the internal surface area per cubic foot of reticulated foam, the increase also increases the material forming the foam. This material increase, increases the back pressure presented to the smoke, thus lowering the differential pressure. Therefore, the number of pores per linear inch must be chosen to prevent an unacceptable decrease of differential draft pressure. Graphs of pressure drop versus pores per linear inch for various air velocities, for typical reticulated foams, are provided in FIG. 7. With these graphs the pore density may be chosen to fit the fireplace characteristics. For example, as indicated by the point 38, a reticulated foam having 10 pores per inch presents a back pressure of 0.1 inches of water to an air flow of 400 feet per minute, 0.18 inches of water to an air flow of 600 feet per minute, and 0.29 inches of water to an air flow of 800 feet per minute. Should the differential pressure between the smoke and the flue be greater than 0.3 inches of water, 10 pores per inch would be an acceptable parameter for the reticulated foam. If the differential pressure is less than 3.0 inches of water, but greater than 2.0 inches of water, 10 pores per inch would only be acceptable for fireplaces in which the air flow is less than 600 feet per minute.

When the reticulated foam is completed, the internal surfaces are coated with a catalyst that converts the pollutants in the fluid passing therethrough to harmless compounds. Transition metals such as platinum, palladium, and rhodium and combinations of platinum and palladium and platinum and rhodium, may be employed as catalysts for the conversion. Additional catalysts may be used, either in mixtures with other catalysts or in separate layers of ceramic foam, in applications when Nitrogen Oxides (NOx), sulfur compounds, or other pollutants may be present that wont be effectively catalyzed by the primary catalysts. Low temperature catalysts and non-ionizing radiation-activated catalysts may be used in applications when high combustion temperatures are not available or appropriate.

The method for forming a reticulated foam structure is well known in the art and structures meeting given specifications are commercially available or are readily manufactured. Such material may be obtained, in accordance with given specifications or as catalog items from a number of sources, two of which are ERG Materials and Aerospace Corporation of Oakland, Calif. and Vesuvius McDanel of Beaver Falls, Pa.

Efficiency of conversion of pollutants to harmless compounds by a catalyst is a function of the temperature to which the catalytic material is exposed. Catalysts operate efficiently at the exhaust temperatures normally created by an actively burning fire. Should the environment in which the catalyst is to operate be at a temperature range in which the catalyst does not achieve an acceptable conversion efficiency, thermostatically controlled heating elements may be included in the reticulated foam structure to increase the temperature of the catalyst.

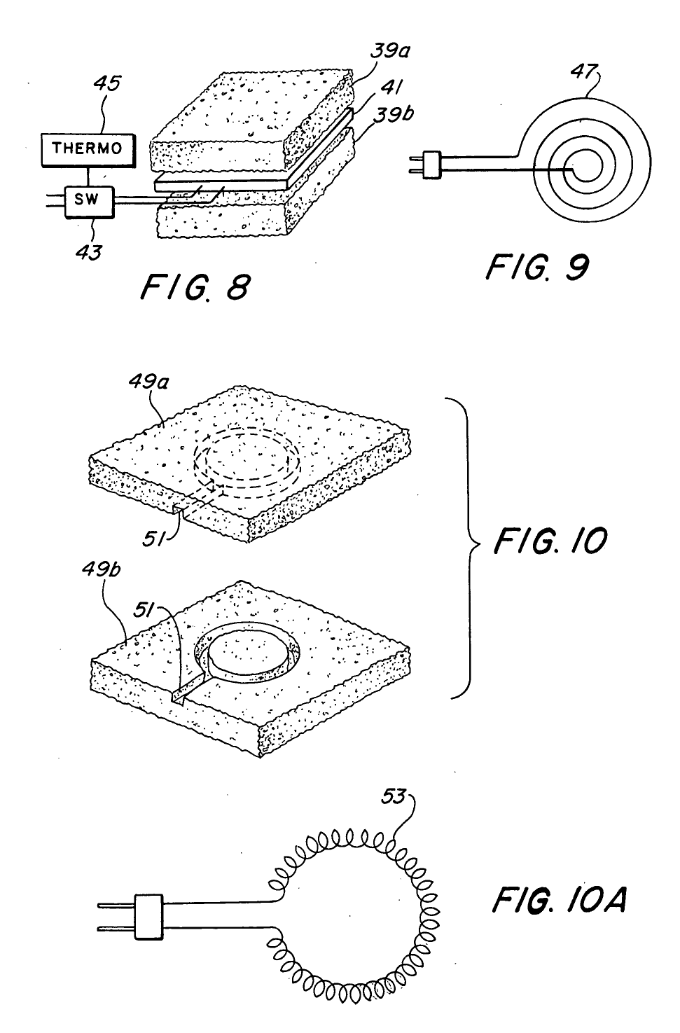

Refer now to FIG. 8, wherein a catalytic cleaner comprising two sections 39a, 39b of catalytic material coated reticulated foam sandwiching a heater element 41 is shown. The heater element may be coupled to a standard 110 volt AC electrical source via a switch 43, which is operated by a thermostat 45, appropriately positioned. Switch 43 may be constructed to be normally in the on position. When the thermostat 45 senses a temperature at or above that required for optimum catalytic conversion efficiency, it causes the switch to turn to the off position, thereby turning the heating element off. The switch remains in the off position until it is thermostatically switched to the on position when the temperature drops below that required for optimum catalytic conversion. A device suitable for use as the heating element 41 may be a spirally shaped electrical conductor 47, shown in FIG. 9, having sufficient electrical resistance to establish the necessary heat.

A heating element may also be provided in a catalyst coated reticulated foam by machining the foam to fit around the heating element. An example of this method for providing a heating element is shown in FIG. 10. Reticulated foam comprising two sections 49a, 49b is machined to provide a circular region 51 into which a heating element, that may made be in the form of a circular helix 53 shown in FIG. 10A, may be imbedded. The circular region 51 may be machined to equal depths in each section, to unequal depths, or in one section only. It should be recognized that the shape of the grove and heating element is not critical, any geometrical shape for the grove and heating element may be used. After the heating element is inserted, the reticulated foam and the heating element may be coated with a catalyst and the two sections fit together to form an integrated unit. Alternatively, the foam may be coated with a catalyst prior to the insertion of the heating element and the fitting together of the two sections.

Another method of providing a heating element to a catalyst coated reticulated foam is shown in FIG. 11. A high resistance electrical conductor, such as a nichrome wire 55 may be woven through a catalyst coated reticulated foam 57. This has the advantage of utilizing a one piece foam structure. But has the disadvantage of finding a wire path through the foam.

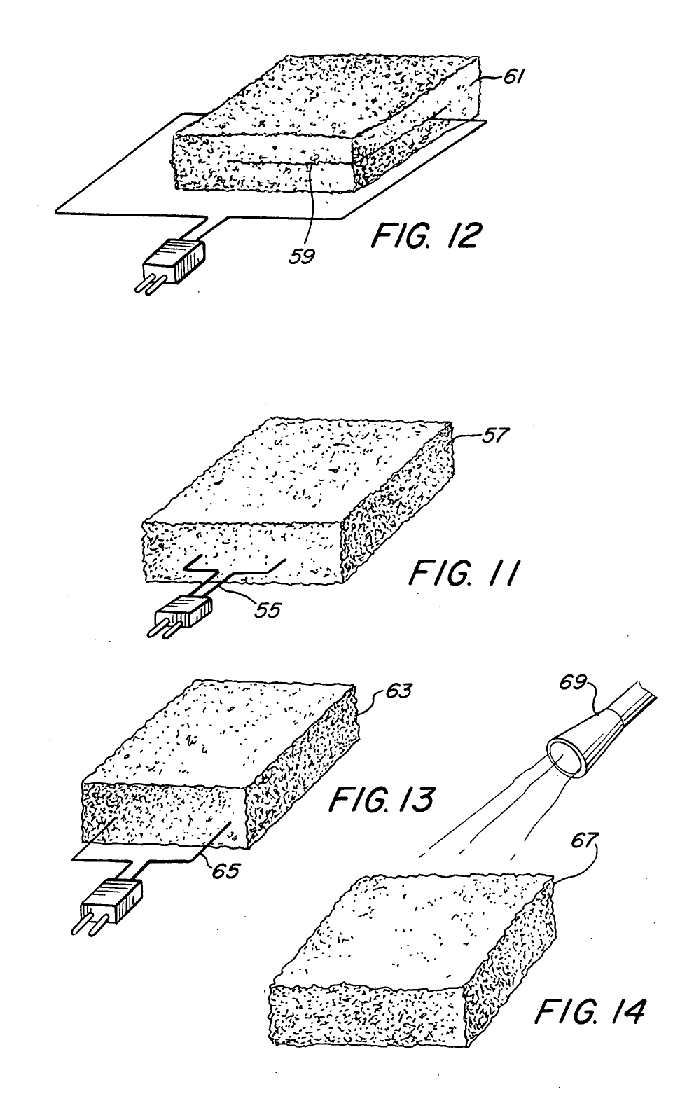

Fully integrated heater-foam units may be provided as shown in FIGS. 12 and 13. In FIG. 12, the inner portion 59 of a catalyst coated reticulated foam 61 may be constructed of high resistance electrical conducting material. An electrical current applied to the inner section will create the heat required for raising the temperature of the entire foam structure.

A catalytic converter is, in general, a poor conductor of electricity, having a high resistance to electrical current. Consequently, current flowing through the catalyst causes it to heat, increasing the temperature of the catalyst, thereby establishing the catalyst as its own heater. FIG. 13 shows a catalyst coated reticulated foam structure 63 with low electrical resistance wiring 65 coupled to the catalyst for applying a source of electrical current.

When high combustion temperatures and other high temperature sources are not available or appropriate, low temperature and non-ionizing radiation-activated catalysts may be used, as shown in FIG. 14. As shown in the figure, a reticulated foam structure coated with a low temperature, non-ionizing, radiation-activated catalyst 67 is positioned in the air flow path. A remotely positioned radiating source 69 illuminates the catalyst with radiation that activates the catalyst. The radiation level of the source is adjusted to activate the catalyst at an efficient operating level.

It should be recognized that the invention as described may be utilized to filter air flow from many types of polluting devices, including but not limited to:
wood burning fireplaces
wood burning stoves
gas burning fireplaces
gas burning stoves
gas, oil, kerosene, diesel coal, and other fuel burning furnaces
gas stoves
Gas water heaters
gas and charcoal barbecues
indoor air cleaners for IAQ improvement
air cleaners for IAQ improvement in automobiles, buses, trains, and ships
air cleaners installed in gas station hoods to reduce escaping gas vapors
air cleaners to reduce pollutants from spray paint operations
air cleaners to reduce volatile organic compounds (VOCs) or other types of airborne pollutants
stack robbers that reduce incinerator, waste wood burner, etc. pollutants
stack robbers that reduce foul smelling compounds from industrial processes
air cleaners for restaurant kitchen hoods
catalytic combustors that reduce hazardous compounds from jet engines
catalytic combustors for large diesel engines
catalytic combustors for recreational vehicles
catalytic combustors for small internal combustion engines—

While the invention has been described in its preferred embodiments, it is to understood that the words that have been used are words of description rather than limitation and that changes may be made within the purview of the appended claims without departing from the true scope and spirit of the invention in its broader aspects.

1. A catalytic converter for reducing pollutants in air or other fluids passing therethrough comprising:
a reticulated foam having internal voids, each void having a volume surrounded by a surface area, said voids, in total, providing a high internal void volume and a high internal surface area; and
a catalyst coating containing at least one transition metal on said internal surface area, thereby creating a catalyst coated reticulated foam.

2. A catalytic converter in accordance with claim 1 wherein said reticulated foam is constructed of a ceramic material.

3. A catalytic converted in accordance with claim 1 further including:
a fluid guide into which said catalyst coated reticulated foam is positioned, thereby guiding said fluids through said catalyst coated reticulated foam, and
a fan positioned in said fluid guide, said fan when activated, maintaining fluid flow through said calalyst coated reticulated foam.

4. A catalytic converter in accordance with claim 1 wherein said at least one transition metal is a combination of platinum and palladium.

5. A catalytic converter in accordance with claim 1 wherein said at least one transition metal is a combination of platinum and rhodium.

6. A catalytic converter in accordance with claim 1 wherein said at least one transition metal is platinum.

7. A catalytic converter in accordance with claim 1 wherein said catalyst coated reticulated foam is constructed to include an electrical heating element.

8. A catalytic converter in accordance with claim 7 further including:
an on-off switch coupled to said heating element; and
a thermostat coupled to said on-off switch.

9. A catalytic converter in accordance with claim 7 wherein said catalyst coated reticulated foam is constructed in first and second sections and said electrical heating element is positioned therebetween.

10. A catalytic converter in accordance with claim 7 wherein said heating element is a spiraled electrical element.

11. A catalytic converter in accordance with claim 7 wherein a geometrically shaped groove of predetermined depth is formed in at least one of said first and second sections and said electrical heating element is shaped to fit within said geometrically shaped groove.

12. A catalytic converter in accordance with claim 11 wherein said geometrically shaped groove is circular and said electrical heating element is constructed to form a circular helix.

13. A catalytic converter in accordance with claim 7 wherein said heating element is an electrical heater coated with catalytic material.

14. A catalytic converter in accordance with claim 7 wherein said heating element is an electrical heater woven through said catalytic coated reticulated foam.

15. A catalytic converter for reducing pollutants in air comprising:
a reticulated foam having internal voids, each void having a volume surrounded by a surface area, said voids, in total, providing a high internal void volume and a high internal surface area; and
a catalyst coated on said internal surface area, thereby creating a catalyst coated reticulated foam, said catalyst coated reticulated foam constructed and arranged for receiving energy from an external source.

16. A catalytic converter in accordance with claim 15 wherein said external source is a combustion process.

17. A catalytic converter in accordance with claim 16 wherein said catalyst coated reticulated foam is constructed and arranged for positioning in a path of emissions from said combustion process.

18. A catalytic converter in accordance with claim 16 wherein said catalyst coated reticulated foam is constructed and arranged for positioning at said combustion process source.

19. A catalytic converter in accordance with claim 15 wherein said external source is a radiating element.

20. A catalytic converter in accordance with claim 19 wherein said catalyst coated reticulated foam is constructed and arranged for positioning in a path of emissions from said radiating element.

21. A method for converting pollutants in a fluid such as air comprising the steps of:
providing a reticulated foam having external porous surfaces and internal voids, each void having a volume surrounded by a surface area, said voids, in total, having a high internal void volume and a high internal surface area;
coating said internal surface area with a catalyst comprising at least one transition metal, thereby providing a coated reticulated foam; and
positioning said coated reticulated foam in a flow path of said fluid.

22. A method for converting pollutants in accordance with claim 21 wherein said providing step includes the steps of:
determining fluid flow velocity;
utilizing said fluid flow velocity to select pore density in said reticulated foam in pores per linear unit.

23. A method for converting pollutants in accordance with claim 21 further including the step of embodying a thermostatically controlled electrical heating element in said reticulated foam.

24. A method for converting pollutants in accordance with claim 21 further including the steps of:
constructing said catalyst coated reticulated foam in first and second sections; and
locating an electrical heating element between said first and second sections.

25. A method for converting pollutants in accordance with claim 21 further including the step of providing energy to said to said catalyst coated reticulated foam from an external energy source.

26. A method for converting pollutants in accordance with claim 25 wherein said external energy source is a radiating element.

27. A method for converting pollutants in accordance with claim 21 further including the step of positioning said radiating element so that emissions therefrom illuminate said catalyst coated reticulated foam.
